(19) United States
(12) Patent Application Publication
(10) Pub. No.: US 2025/0190907 A1
(43) Pub. Date: Jun. 12, 2025

(54) DATA PROCESSING METHOD AND APPARATUS, COMPUTER DEVICE, AND READABLE STORAGE MEDIUM

(71) Applicant: Tencent Technology (Shenzhen) Company Limited, Shenzhen (CN)

(72) Inventors: Jianing ZHAO, Shenzhen (CN); Lina Gao, Shenzhen (CN); Siliang Liu, Shenzhen (CN); Kai Hong, Shenzhen (CN); Shili Xu, Shenzhen (CN); Jiazhong Shen, Shenzhen (CN); Di Zhang, Shenzhen (CN); Zhenxing Wang, Shenzhen (CN); Wenjie Cai, Shenzhen (CN); Zhuan Liu, Shenzhen (CN); Xun Sun, Shenzhen (CN); Jihong Wang, Shenzhen (CN)

(21) Appl. No.: 19/060,544

(22) Filed: Feb. 21, 2025

Related U.S. Application Data
(63) Continuation of application No. PCT/CN2024/080336, filed on Mar. 6, 2024.

(30) Foreign Application Priority Data
Mar. 17, 2023 (CN) 202310291538.1

(51) Int. Cl. G06Q 10/0631

(52) U.S. Cl. CPC G06Q 10/06315

(57) ABSTRACT

This application provides a data processing method performed by a computer device. The method includes: obtaining a pre-downloaded business resource corresponding to a business application, and storing the pre-downloaded business resource into a terminal directory corresponding to a terminal device, the business application including an optimization component and a business component; obtaining, by the business component in response to a trigger operation for the business application, a resource list matching a download mode and an object business feature, and transmitting the resource list to the optimization component, the resource list including resource configuration information; determining a filter matching resource in the pre-downloaded business resource according to the resource configuration information in the resource list, and migrating the filter matching resource from the terminal directory to an application directory corresponding to the business application; and updating the business application based on the filter matching resource in the application directory.

### CROSS-REFERENCE TO RELATED APPLICATIONS

This application is a continuation application of PCT Patent Application No. PCT/CN2024/080336, entitled “DATA PROCESSING METHOD AND APPARATUS, COMPUTER DEVICE, AND READABLE STORAGE MEDIUM” filed on Mar. 6, 2024, which claims priority to Chinese Patent Application No. 2023102915381, entitled “DATA PROCESSING METHOD AND APPARATUS, COMPUTER DEVICE, AND READABLE STORAGE MEDIUM” and filed with the China National Intellectual Property Administration on Mar. 17, 2023, both of which are incorporated by reference in their entirety.

### FIELD OF THE TECHNOLOGY

Embodiments of this application relate to the field of computer technologies, and in particular, to a data processing method and apparatus, a computer device, and a readable storage medium.

### BACKGROUND OF THE DISCLOSURE

According to an existing application update method, after a full update resource (for example, a game resource) corresponding to a business application (for example, a game client) is issued and updated, the full update resource may start to be downloaded in response to a trigger operation for the business application, and the business application may be updated based on the full update resource after the full update resource is downloaded completely. However, according to the existing application update method, it is required to wait for completely downloading the full update resource on a resource download interface of the business application. When a file size of the full update resource is relatively large, long time (for example, 1 h) for staying on the resource download interface of the business application is required, and time for updating the business application is prolonged, thereby reducing update efficiency for the business application.

### SUMMARY

Embodiments of this application provide a data processing method and apparatus, a computer device, and a readable storage medium, to improve update efficiency for a business application.

According to an aspect of this embodiment of this application, a data processing method is performed by a computer device, the method including: storing a pre-downloaded business resource corresponding to a business application into a terminal directory corresponding to a terminal device, where the business application includes an optimization component and a business component; obtaining, in response to a trigger operation for the business application, a resource list matching a download mode and an object business feature, and transmitting the resource list to the optimization component, where the object business feature is a business feature of a business object corresponding to the terminal device in the business application, the resource list includes resource configuration information, and a business resource indicated by the resource configuration information belongs to the full update resource; determining a filter matching resource in the pre-downloaded business resource according to the resource configuration information in the resource list, and migrating the filter matching resource from the terminal directory to an application directory corresponding to the business application; and updating the business application based on the filter matching resource in the application directory.

According to an aspect of this embodiment of this application, a computer device is provided, including: a processor and a memory.

The processor and the memory are connected. The memory is configured to store a computer program. The computer program, when executed by the processor, causes the computer device to perform the method provided in this embodiment of this application.

According to an aspect of this embodiment of this application, a non-transitory computer-readable storage medium is provided. The computer-readable storage medium has a computer program stored therein. The computer program is adapted to be loaded and executed by a processor, to cause a computer device having the processor to perform the method provided in this embodiment of this application.

In this embodiment of this application, after a full update resource corresponding to a business application is issued and updated, a pre-downloaded business resource corresponding to the business application may be obtained by pre-downloading based on the full update resource in advance. Then, in response to a trigger operation for the business application, a filter matching resource is determined in the pre-downloaded business resource according to resource configuration information in a resource list, and the business application is updated based on the filter matching resource. In this case, instead of downloading the filter matching resource in response to the trigger operation for the business application, a computer device directly modifies a file path of the filter matching resource in the computer device (to be specific, the filter matching resource is migrated from a terminal directory to an application directory). Regardless of a file size of the filter matching resource, an operation of modifying the file path does not occupy a long time, and time for updating the business application can be shortened, thereby improving update efficiency for the business application.

### BRIEF DESCRIPTION OF THE DRAWINGS

FIG. 1 is a schematic structural diagram of a network architecture according to an embodiment of this application.

FIG. 2 is a schematic diagram of a data interaction scenario according to an embodiment of this application.

FIG. 3 is a schematic flowchart of a data processing method according to an embodiment of this application.

FIG. 4A is a schematic diagram of a component interaction scenario according to an embodiment of this application.

FIG. 4B is a schematic diagram of a component interaction scenario according to an embodiment of this application.

FIG. 5 is a schematic flowchart of a data processing method according to an embodiment of this application.

FIG. 6 is a schematic flowchart of a data processing method according to an embodiment of this application.

FIG. 7 is a schematic structural diagram of a data processing apparatus according to an embodiment of this application.

FIG. 8 is a schematic structural diagram of a computer device according to an embodiment of this application.

### DESCRIPTION OF EMBODIMENTS

Technical solutions in embodiments of this application will be clearly and completely described in the following with reference to the accompanying drawings in the embodiments of this application. It is clear that the described embodiments are merely some rather than all of the embodiments of this application. All other embodiments obtained by a person of ordinary skill in the art based on the embodiments of this application without making creative efforts shall fall within the protection scope of this application.

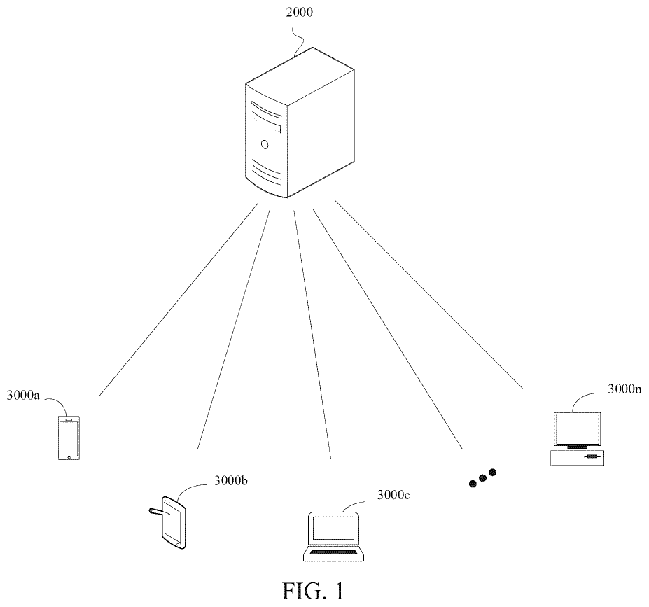

Specifically, refer to FIG. 1. FIG. 1 is a schematic structural diagram of a network architecture according to an embodiment of this application. As shown in FIG. 1, the network architecture may include a server 2000 and a terminal device cluster. The terminal device cluster may specifically include one or more terminal devices. The number of terminal devices in the terminal device cluster is not limited herein. As shown in FIG. 1, the plurality of terminal devices may specifically include a terminal device 3000a, a terminal device 3000b, a terminal device 3000c, . . . , and a terminal device 3000n. The terminal device 3000a, the terminal device 3000b, the terminal device 3000c, . . . , and the terminal device 3000n may be in direct or indirect network connection with the server 2000 by wired or wireless communication, so that each of the terminal devices may perform data interaction with the server 2000 via the network connection.

Each terminal device in the terminal device cluster may include: a smart terminal having a data processing function, such as a smartphone, a tablet computer, a laptop computer, a desktop computer, a smart voice interaction device, a smart home appliance (for example, a smart TV), a wearable device, an in-vehicle terminal, or an aircraft. Each terminal device in the terminal device cluster shown in FIG. 1 may be installed with an application client having a data processing function. When running in each terminal device, the application client may perform data interaction with the server 2000 shown in FIG. 1. The application client may specifically include: an in-vehicle client, a smart home client, an entertainment client (for example, a game client), a multimedia client (for example, a video client), a social client, an information client (for example, a news client), and the like. The application client in this embodiment of this application may be integrated into a client (for example, a social client), or the application client may be an independent client (for example, a news client). The type of the application client is not limited in this embodiment of this application.

To facilitate understanding, in this embodiment of this application, one terminal device may be selected from the plurality of terminal devices shown in FIG. 1 as a target terminal device. For example, in this embodiment of this application, the terminal device 3000a shown in FIG. 1 may be used as a target terminal device, and an application client having a data processing function may be installed in the target terminal device. In this case, the target terminal device may implement data interaction with the server 2000 by using the application client.

To facilitate understanding, this embodiment of this application is described by using an example in which the application client in the target terminal device includes a business application and a service application. The business application may be an application client to which an application is to be updated (for example, the business application may be a game client to which an application is to be updated). The service application may be a manufacturer node of the target terminal device (i.e. an application store of a terminal manufacturer). The server 2000 may be a server corresponding to the business application, or may be a server corresponding to the service application. To facilitate understanding, this embodiment of this application is described by using an example in which the server 2000 is a server corresponding to the service application.

The server 2000 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The foregoing network framework may be applicable to an application update scenario (for example, a game client update scenario). In the application update scenario, the computer device in this embodiment of this application may obtain a pre-downloaded business resource corresponding to a business application, obtain, in response to a trigger operation for the business application, a resource list matching a download mode and an object business feature, determine a filter matching resource in the pre-downloaded business resource according to resource configuration information in the resource list, and then update the business application based on the filter matching resource. Therefore, in this embodiment of this application, the pre-downloaded business resource may be pre-download, to save time for a user corresponding to the target terminal device (to facilitate understanding, in this embodiment of this application, a user corresponding to a terminal device may be referred to as a business object), so that the business object may quickly use the updated business application after the business application is updated, thereby improving update efficiency for the business application (for example, improving application update efficiency for a game client). Furthermore, in this embodiment of this application, a CDN peak caused by online downloading of a large quantity of business objects together after the business application is formally issued and updated may be reduced in a pre-downloading mode, thereby reducing CDN costs.

The pre-downloading means downloading, for the business object in advance before an update resource (i.e. a full update resource) of the business application is formally updated and issued, a pre-downloaded business resource (for example, a game resource) that needs to be downloaded for a relatively long time. At a time node for formally using the pre-downloaded business resource, the pre-downloaded business resource downloaded in advance may be directly processed to perform application update (for example, game update), and a task of downloading the pre-downloaded business resource does not need to be started only after the business application (for example, the game client) is entered. The pre-downloaded business resource refers to an application installation package or an application resource package. There may be one or more application resource packages. The pre-downloaded business resource may be one or more of an application installation package or one or more application resource packages. For example, the game resource may be one or more of a game installation package (for example, an Android application package (APK) file) or one or more game resource packages (for example, a compressed file format (PAK) file). To be specific, the game resource may be one or more of a game installation package and a game resource package. In some embodiments, the pre-downloaded business resource may alternatively be an animation resource, an interaction resource, a user interface (UI) resource, or the like in the business application.

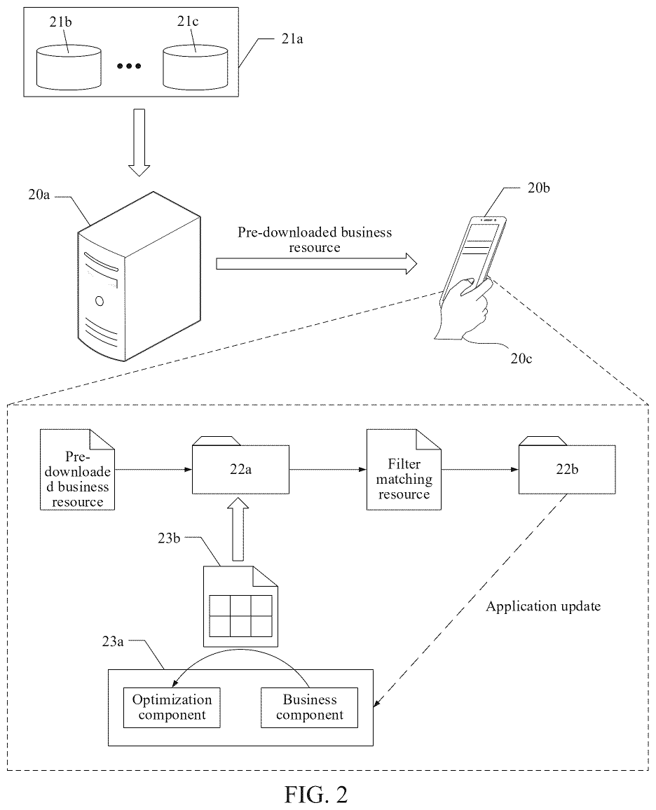

To facilitate understanding, further, refer to FIG. 2. FIG. 2 is a schematic diagram of a data interaction scenario according to an embodiment of this application. A server 20a shown in FIG. 2 may be the server 2000 in the foregoing embodiment corresponding to FIG. 1. A terminal device 20b shown in FIG. 2 may be the target terminal device in the foregoing embodiment corresponding to FIG. 1. A user corresponding to the terminal device 20b may be a business object 20c. To facilitate understanding, this embodiment of this application is described by using an example in which the data processing method is performed by the terminal device 20b.

An application database 21a shown in FIG. 2 may store a full update resource of an application client in the terminal device 20b. The application client in the terminal device 20b may include a business application. The application database 21a may store a full update resource of the business application. The application database 21a may be separately disposed, or may be integrated onto the server 20a, or integrated onto another device or cloud. This is not limited herein.

As shown in FIG. 2, the server 20a may obtain, from the application database 21a, a pre-downloaded business resource corresponding to the business application, and transmit the pre-downloaded business resource to the terminal device 20b. The pre-downloaded business resource is obtained based on a full update resource in the server 20a. The pre-downloaded business resource may be a full update resource corresponding to the business application, or may be a differential update resource in the full update resource (i.e. an update resource for the business object 20c in the full update resource). This is not limited in this application.

The application database 21a may include a plurality of databases. The plurality of databases may specifically include: a database 21b, . . . , and a database 21c. The database 21b, . . . , and the database 21c may be configured to store full update resources corresponding to application clients of different application types. For example, the database 21b may be configured to store a full update resource corresponding to a social-type application client, and the database 21c may be configured to store a full update resource corresponding to a game-type application client. Therefore, when the business application is the game-type application client, the server 20a may obtain, from the database 21b, a pre-downloaded business resource corresponding to a game-type business application.

As shown in FIG. 2, the terminal device 20b may receive a pre-downloaded business resource transmitted by the server 20a, and store the pre-downloaded business resource into a terminal directory 22a corresponding to the terminal device 20b. In this way, when the business object 20c performs a trigger operation for the business application in the terminal device 20b, the terminal device 20b may determine, by the business application in response to the trigger operation for the business application, an object business feature of the business object 20c in the business application and a download mode of the business application, and obtain a resource list 23b matching the download mode and the object business feature. The business application may include an optimization component and a business component. The terminal device 20b may determine, by the business component, an object business feature of the business object 20c in the business application and a download mode of the business application, obtain the resource list 23b matching the download mode and the object business feature, and transmit the resource list 23b to the optimization component.

The resource list 23b may include resource configuration information. A business resource indicated by the resource configuration information belongs to the full update resource. The resource configuration information may be full resource configuration information or differential resource configuration information. A business resource indicated by the full resource configuration information is a full update resource. A business resource indicated by the differential resource configuration information is a differential update resource.

Further, as shown in FIG. 2, the terminal device 20b may determine a filter matching resource in the pre-downloaded business resource according to the resource configuration information in the resource list 23b, and migrating the filter matching resource from the terminal directory 22a to an application directory 22b corresponding to the business application. When the pre-downloaded business resource is a full update resource, the filter matching resource may be a full update resource determined in the full update resource according to the full resource configuration information, or may be a differential update resource determined in the full update resource according to the differential resource configuration information. In some embodiments, when the pre-downloaded business resource is a differential update resource, the filter matching resource may be a differential update resource determined in the differential update resource according to the differential resource configuration information.

Further, as shown in FIG. 2, the terminal device 20b may update the business application based on the filter matching resource in the application directory 22b, to obtain an updated business application, so that the business object 20c may quickly use the updated business application by the terminal device 20b.

As can be seen, in this embodiment of this application, a filter matching resource (the filter matching resource belongs to a pre-downloaded business resource) used when a business application (for example, a game application) is updated may be pre-downloaded to a terminal directory. In this way, in response to a trigger operation for the business application, a terminal device may migrate, by a resource list matching a download mode and an object business feature, the filter matching resource in the pre-downloaded business resource that is pre-downloaded, and implement update of the business application by using the migrated filter matching resource, thereby shortening time for obtaining the filter matching resource used for application update, i.e. shortening time for updating the business application, and improving update efficiency for the business application. Furthermore, when a business object does not use the business application for a long time, the application update method in this embodiment of this application can improve regression probability and enthusiasm of the business object.

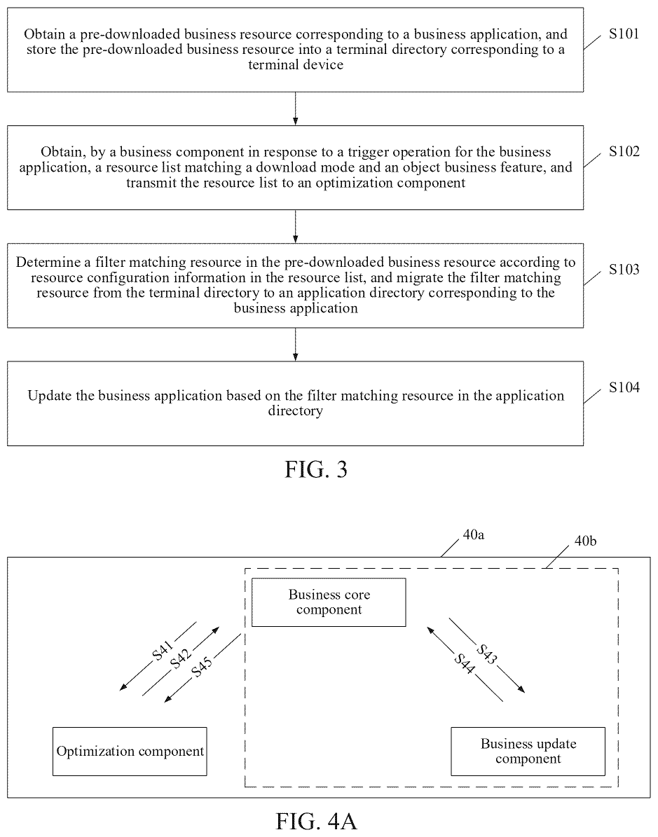

Further, refer to FIG. 3. FIG. 3 is a schematic flowchart of a data processing method according to an embodiment of this application. The method may be performed by a server, or may be performed by a terminal device, or may be performed by both a server and a terminal device. The server may be the server 20a in the foregoing embodiment corresponding to FIG. 2. The terminal device may be the terminal device 20b in the foregoing embodiment corresponding to FIG. 2. To facilitate understanding, this embodiment of this application is described by using an example in which the method is performed by a terminal device. The data processing method may include the following operations S101 to S104.

Operation S101: Obtain a pre-downloaded business resource corresponding to a business application, and store the pre-downloaded business resource into a terminal directory corresponding to a terminal device.

The business application may include an optimization component and a business component. The business component may include a business core component and a business update component. In other words, the business application may include an optimization component, a business application (to be specific, the business core component may be understood as a business application excluding the optimization component and the business update component), and a business update component (for example, a game update component).

When the business application is a game client, the optimization component may be a Tencent game performance amelioration (TGPA) component. The TGPA component opens a game and a terminal operating system, and constructs a bridge between a game and a mobile phone manufacturer. By means of in-depth analysis of a game scenario, an upper layer is uniformly connected to each game, and a bottom layer is connected to different manufacturers, thereby implementing a unified game performance solution. In this case, the game client may include a TGPA component, a game, and a game update component.

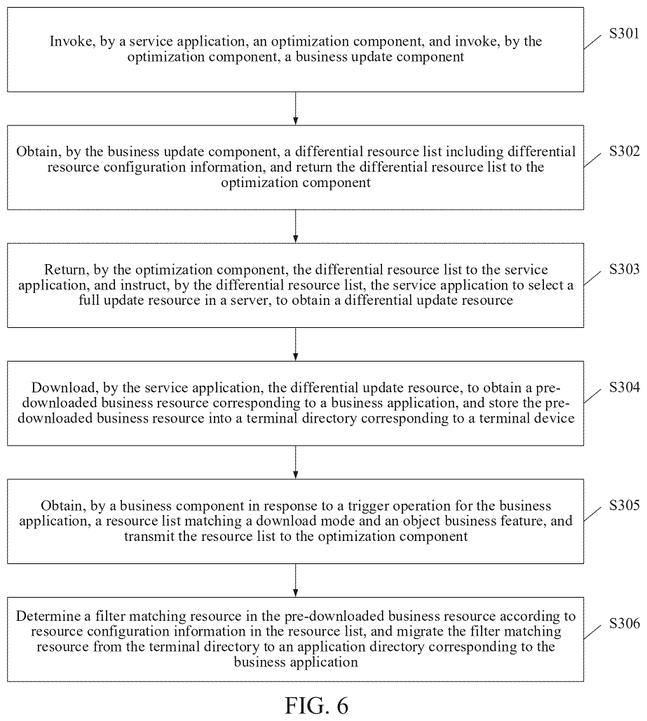

The pre-downloaded business resource is obtained based on a full update resource in the server. The full update resource may include a differential update resource. The pre-downloaded business resource may be obtained by downloading the full update resource, or may be obtained by downloading the differential update resource. For a specific process in which the terminal device downloads the full update resource to obtain a pre-downloaded business resource corresponding to the business application, refer to the descriptions for operation S201 to operation S202 in the following embodiment corresponding to FIG. 5. For a specific process in which the terminal device downloads the differential update resource to obtain a pre-downloaded business resource corresponding to the business application, refer to the descriptions for operation S301 to operation S304 in the following embodiment corresponding to FIG. 6.

After the full update resource is issued and updated, the terminal device may detect an idle time of the terminal device by a service application (i.e. a game service side), pull a pre-download service in the idle time of the terminal device, and obtain, by the pre-download service, the pre-downloaded business resource corresponding to the business application in a time that does not affect normal use of the terminal device. The service application may be pre-downloaded before a time node for formally issuing the full update resource, or may be pre-downloaded after the time node for formally issuing the full update resource.

Operation S102: Obtain, by the business component in response to a trigger operation for the business application, a resource list matching a download mode and an object business feature, and transmit the resource list to the optimization component.

Specifically, the terminal device may transmit, by the business core component in response to the trigger operation for the business application, a migration query request to the optimization component, and instruct, by the migration query request, the optimization component to generate migration success information based on the pre-downloaded business resource in the terminal directory. Further, the terminal device may receive, by the business core component, the migration success information returned by the optimization component, and invoke the business update component according to the migration success information. Further, the terminal device may obtain, by the business update component, a resource list matching the download mode and the object business feature, and return the resource list to the business core component. The object business feature is a business feature of a business object corresponding to the terminal device in the business application. The resource list includes resource configuration information. A business resource indicated by the resource configuration information belongs to the full update resource. Further, the terminal device may transmit, by the business core component, the resource list to the optimization component.

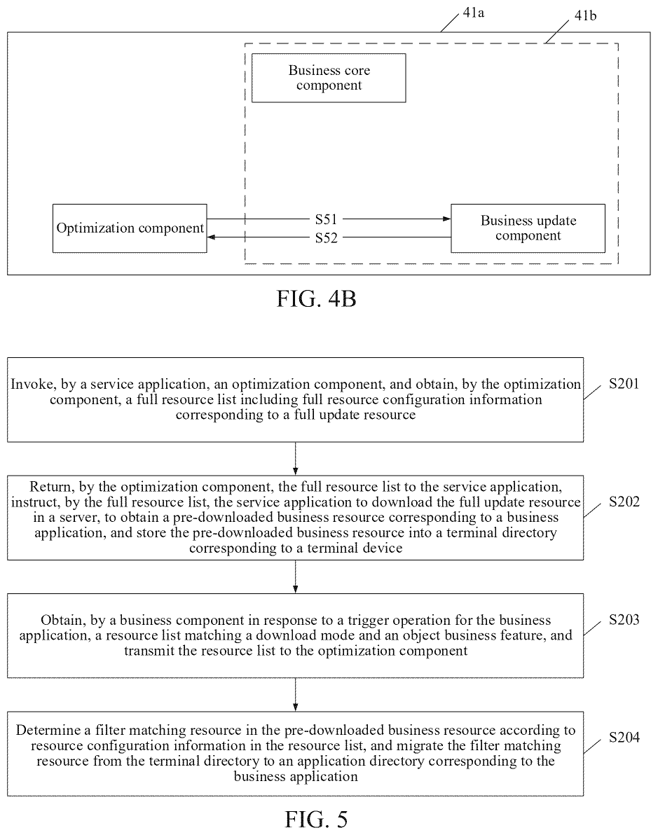

For a specific process in which the optimization component, the business core component, and the business update component interact with each other, refer to FIG. 4A. FIG. 4A is a schematic diagram of a component interaction scenario according to an embodiment of this application. As shown in FIG. 4A, a business application 40a may include an optimization component and a business component 40b. The business component 40b may include a business core component and a business update component. The optimization component, the business core component, and the business update component may perform operation S41 to operation S45. The business core component may be used as an intermediate information transmitter to implement full downloading (or differential downloading) and full migration (or differential migration).

As shown in FIG. 4A, in response to the trigger operation for the business application, the terminal device may perform operation S41. In operation S41, the terminal device may transmit, by the business core component, a migration query request to the optimization component. In this way, the terminal device may receive, by the optimization component, the migration query request transmitted by the business core component, and generate migration success information based on the pre-downloaded business resource in the terminal directory. Further, the terminal device may perform operation S42. In operation S42, the terminal device may return, by the optimization component, the migration success information to the business core component. In this way, the terminal device may receive, by the business core component, the migration success information returned by the optimization component.

Further, as shown in FIG. 4A, the terminal device may perform operation S43. In operation S43, the terminal device may invoke, by the business core component, the business update component. In this way, the terminal device may obtain, by the business update component, a resource list matching the download mode and the object business feature. Further, the terminal device may perform operation S44. In operation S44, the terminal device may return, by the business update component, the resource list to the business core component. In this way, the terminal device may receive, by the business core component, the resource list returned by the business update component.

Further, as shown in FIG. 4A, the terminal device may perform operation $45. In operation S45, the terminal device may transmit, by the business core component, the resource list to the optimization component. In this way, the terminal device may receive, by the optimization component, the resource list transmitted by the business core component.

When a pre-downloaded resource exists in the terminal directory, the terminal device may generate migration success information based on the pre-downloaded business resource in the terminal directory, receive, by the business core component, the migration success information returned by the optimization component, and invoke the business update component according to the migration success information. In some embodiments, when no pre-downloaded resource exists in the terminal directory, the terminal device may generate migration failure information (i.e. migration failure information) based on that no pre-downloaded resource exists in the terminal directory, and then receive, by the business core component, the migration failure information returned by the optimization component, so that the business update component does not need to be invoked.

In some embodiments, the terminal device may generate, by the optimization component in response to the trigger operation for the business application, migration success information based on the pre-downloaded business resource in the terminal directory, and invoke the business update component according to the migration success information. Further, the terminal device may obtain, by the business update component, a resource list matching the download mode and the object business feature, and transmit the resource list to the optimization component. The object business feature is a business feature of a business object corresponding to the terminal device in the business application. The resource list includes resource configuration information. A business resource indicated by the resource configuration information belongs to the full update resource.

For a specific process in which the optimization component and the business update component interact with each other, refer to FIG. 4B. FIG. 4B is a schematic diagram of a component interaction scenario according to an embodiment of this application. As shown in FIG. 4B, a business application 41a may include an optimization component and a business component 41b. The business component 41b may include a business core component and a business update component. The optimization component and the business update component may perform operation S51 to operation S52. The optimization component always interacts with the business update component, to implement full downloading (or differential downloading) and full migration (or differential migration).

As shown in FIG. 4B, in response to the trigger operation for the business application, the terminal device may perform operation S51. In operation S51, the terminal device may generate, by the optimization component, migration success information based on the pre-downloaded business resource in the terminal directory, and invoke the business update component according to the migration success information. In this way, the terminal device may obtain, by the business update component, a resource list matching the download mode and the object business feature.

Further, as shown in FIG. 4B, the terminal device may perform operation S52. In operation S52, the terminal device may transmit, by the business update component, the resource list to the optimization component. In this way, the terminal device may receive, by the optimization component, the resource list transmitted by the business update component.

When a pre-downloaded resource exists in the terminal directory, the terminal device may generate migration success information based on the pre-downloaded business resource in the terminal directory, and then invoke the business update component according to the migration success information. In some embodiments, when no pre-downloaded resource exists in the terminal directory, the terminal device may generate migration failure information (i.e. migration failure information) based on that no pre-downloaded resource exists in the terminal directory. Then, the business update component does not need to be invoked.

The resource configuration information in the resource list may include a resource name and resource digest information. The resource configuration information may be full resource configuration information in the full resource list or differential resource configuration information in the differential resource list. In other words, the full resource configuration information may include a resource name and resource digest information. The differential resource configuration information may include a resource name and resource digest information. The resource name and the resource digest information may be configured for performing the following operation S103. To be specific, the terminal device may determine a filter matching resource in the pre-downloaded business resource according to the resource name and the resource digest information, and migrate the filter matching resource from the terminal directory to an application directory corresponding to the business application.

Operation S103: Determine a filter matching resource in the pre-downloaded business resource according to the resource configuration information in the resource list, and migrate the filter matching resource from the terminal directory to an application directory corresponding to the business application.

Specifically, the terminal device may verify, if the resource configuration information in the resource list is full resource configuration information, the pre-downloaded business resource according to the resource digest information, to obtain a first resource verification result, and determine, if the first resource verification result indicates a verification success of the pre-downloaded business resource, the pre-downloaded business resource as a filter matching resource. Further, the terminal device may migrate the filter matching resource from the terminal directory to an application directory corresponding to the business application. In some embodiments, if the first resource verification result indicates a verification failure of the pre-downloaded business resource (to be specific, the verification fails), the terminal device cannot determine the filter matching resource, and further cannot perform the operation of migrating the filter matching resource and the operation of updating the business application in the following operation S104.

If the resource configuration information in the resource list is full resource configuration information and the first resource verification result indicates a verification success of the pre-downloaded business resource, the pre-downloaded business resource is a resource obtained by downloading the full update resource, and the pre-downloaded business resource is the same as the full update resource. In some embodiments, if the resource configuration information in the resource list is full resource configuration information and the first resource verification result indicates a verification failure of the pre-downloaded business resource, the pre-downloaded business resource is a resource obtained by downloading the full update resource, and the pre-downloaded business resource is different from the full update resource.

In some embodiments, the terminal device may filter, if the resource configuration information in the resource list is differential resource configuration information, the pre-downloaded business resource according to the resource name, to obtain a pre-downloaded filtered resource, verify the pre-downloaded filtered resource according to the resource digest information, to obtain a second resource verification result, and determine, if the second resource verification result indicates a verification success of the pre-downloaded filtered resource, the pre-downloaded filtered resource as a filter matching resource. Further, the terminal device may migrate the filter matching resource from the terminal directory to an application directory corresponding to the business application. In some embodiments, if the second resource verification result indicates a verification failure of the pre-downloaded filtered resource (to be specific, the verification fails), the terminal device cannot determine the filter matching resource, and further cannot perform the operation of migrating the filter matching resource and the operation of updating the business application in the following operation S104.

If the resource configuration information in the resource list is differential resource configuration information and the second resource verification result indicates a verification success of the pre-downloaded filtered resource, the pre-downloaded business resource is a resource obtained by downloading the full update resource, and the pre-downloaded business resource is the same as the full update resource. Alternatively, the pre-downloaded business resource is obtained by downloading the differential update resource, and the pre-downloaded business resource is the same as the differential update resource. In some embodiments, if the resource configuration information in the resource list is differential resource configuration information and the second resource verification result indicates a verification failure of the pre-downloaded filtered resource, the pre-downloaded business resource is a resource obtained by downloading the full update resource, and the pre-downloaded business resource is different from the full update resource. Alternatively, the pre-downloaded business resource is obtained by downloading the differential update resource, and the pre-downloaded business resource is different from the differential update resource. If the pre-downloaded business resource is a resource obtained by downloading the full update resource, the terminal device may obtain, from the full update resource according to the resource name, a pre-downloaded filtered resource matching the differential resource configuration information. In some embodiments, if the pre-downloaded business resource is obtained by downloading the differential update resource, the terminal device may determine the pre-downloaded business resource as the pre-downloaded filtered resource matching the differential resource configuration information.

Therefore, when the resource configuration information in the resource list is differential resource configuration information, since different business objects correspond to different object business features, the terminal device may generate different resource lists for different business objects, and may further determine different filter matching resources in the pre-downloaded business resource according to the different resource lists, thereby implementing varied (i.e. user differentiation) application updates. For example, when the business application is a game client, the variation indicates that the game client may customize and update a game resource (i.e. a filter matching resource) for each business object according to an object business feature (e.g. user gameplay) when downloading resources in the game client. In this case, business objects with different object business features actually update different game resources in a game client update.

A specific process in which the terminal device verifies the pre-downloaded business resource according to the resource digest information to obtain a first resource verification result may be described as: The terminal device may perform hash calculation on the pre-downloaded business resource, to obtain download digest information corresponding to the pre-downloaded business resource, and match the download digest information (i.e. the download digest information corresponding to the pre-downloaded business resource) with the resource digest information. Further, if the download digest information (i.e. the download digest information corresponding to the pre-downloaded business resource) is the same as the resource digest information, the terminal device may generate a first resource verification result for indicating a verification success of the pre-downloaded business resource. In some embodiments, if the download digest information (i.e. the download digest information corresponding to the pre-downloaded business resource) is different from the resource digest information, the terminal device may generate a first resource verification result for indicating a verification failure of the pre-downloaded business resource.

A specific algorithm used for hash calculation is not limited in this embodiment of this application. For example, the download digest information and the resource digest information may be hash values generated by using an MD5 message-digest algorithm, and are configured for ensuring complete and consistent transmission of information. To be specific, the terminal device may perform hash calculation by using the MD5 message-digest algorithm.

Similarly, a specific process in which the terminal device verifies the pre-downloaded filtered resource according to the resource digest information to obtain a second resource verification result may be described as: The terminal device may perform hash calculation on the pre-downloaded filtered resource, to obtain download digest information corresponding to the pre-downloaded filtered resource, and match the download digest information (i.e. the download digest information corresponding to the pre-downloaded filtered resource) with the resource digest information. Further, if the download digest information (i.e. the download digest information corresponding to the pre-downloaded filtered resource) is the same as the resource digest information, the terminal device may generate a second resource verification result for indicating a verification success of the pre-downloaded filtered resource. In some embodiments, if the download digest information (i.e. the download digest information corresponding to the pre-downloaded filtered resource) is different from the resource digest information, the terminal device may generate a second resource verification result for indicating a verification failure of the pre-downloaded filtered resource.

In some embodiments, if the resource configuration information in the resource list is full resource configuration information, the terminal device may verify the pre-downloaded business resource according to the resource digest information and the resource name, to obtain a first resource verification result. The terminal device may perform hash calculation on the pre-downloaded business resource, to obtain download digest information corresponding to the pre-downloaded business resource, and match the download digest information (i.e. the download digest information corresponding to the pre-downloaded business resource) with the resource digest information. Further, if the download digest information (i.e. the download digest information corresponding to the pre-downloaded business resource) is the same as the resource digest information, the terminal device may generate a first candidate resource verification result for indicating a verification success of the pre-downloaded business resource. In some embodiments, if the download digest information (i.e. the download digest information corresponding to the pre-downloaded business resource) is different from the resource digest information, the terminal device may generate a first candidate resource verification result for indicating a verification failure of the pre-downloaded business resource. Further, the terminal device may match the resource name with a name of the pre-downloaded business resource. If the resource name matches the name of the pre-downloaded business resource, the terminal device may generate a second candidate resource verification result for indicating a verification success of the pre-downloaded business resource. In some embodiments, if the resource name does not match the name of the pre-downloaded business resource, the terminal device may generate a second candidate resource verification result for indicating a verification failure of the pre-downloaded business resource. Further, if both the first candidate resource verification result and the second candidate resource verification result indicate a verification success of the pre-downloaded business resource, the terminal device may generate a first resource verification result for indicating a verification success of the pre-downloaded business resource. In some embodiments, if the first candidate resource verification result or the second candidate resource verification result indicates a verification failure of the pre-downloaded business resource, the terminal device may generate a first resource verification result for indicating a verification failure of the pre-downloaded business resource.

To facilitate understanding, this embodiment of this application is described by using an example in which a business resource having a name matching the resource name exists in the pre-downloaded business resource. In this case, a specific process in which the terminal device filters the pre-downloaded business resource according to the resource name to obtain a pre-downloaded filtered resource may be described as: The terminal device may obtain, from the pre-downloaded business resource, a business resource having a name matching the resource name, and determine the business resource having the name matching the resource name as a pre-downloaded filtered resource. In some embodiments, if a business resource having a name matching the resource name does not exist in the pre-downloaded business resource, the terminal device cannot determine a pre-downloaded filtered resource, cannot determine a filter matching resource, and cannot perform the operation of updating the business application in the following operation S104.

The migration of the filter matching resource from the terminal directory to the application directory represents file migration on the filter matching resource, where the file migration represents cutting and pasting a series of files from a directory to another directory. For example, the file migration represents that the terminal device may cut and paste a game resource from a public download directory (i.e. the terminal directory) of the terminal device to a private directory (i.e. the application directory) of a game.

Operation S104: Update the business application based on the filter matching resource in the application directory.

Specifically, the terminal device may set the application directory to a pre-download directory, and read the filter matching resource in the pre-download directory. In other words, the terminal device may enable the business application to use the pre-download directory, and use the filter matching resource in the pre-download directory. In this case, a directory in which the filter matching resource resides is either the application directory or the pre-download directory. Further, the terminal device may update the business application according to the filter matching resource. The terminal device may install and update the business application according to the filter matching resource, or update the business application according to the filter matching resource.

If the terminal device responds to the trigger operation for the business application after formally issuing a time node for updating the full update resource, the terminal device directly loads and uses the downloaded filter matching resource, thereby reducing time costs of the business object and optimizing user experience. In some embodiments, if the terminal device responds to the trigger operation for the business application before formally issuing the time node for updating the full update resource, the terminal device cannot directly load and use the downloaded filter matching resource.

As can be seen, in this embodiment of this application, after a full update resource corresponding to a business application is issued and updated, a pre-downloaded business resource corresponding to the business application may be obtained by pre-downloading based on the full update resource in advance. Then, in response to a trigger operation for the business application, a filter matching resource is determined in the pre-downloaded business resource according to resource configuration information in a resource list, and the business application is updated based on the filter matching resource. In this case, instead of downloading the filter matching resource in response to the trigger operation for the business application, a computer device directly modifies a file path of the filter matching resource in the computer device (to be specific, the filter matching resource is migrated from a terminal directory to an application directory). Regardless of a file size of the filter matching resource, an operation of modifying the file path does not occupy a long time, and time for updating the business application can be shortened, thereby improving update efficiency for the business application.

Further, refer to FIG. 5. FIG. 5 is a schematic flowchart of a data processing method according to an embodiment of this application. The method may be performed by a server, or may be performed by a terminal device, or may be performed by both a server and a terminal device. The server may be the server 20a in the foregoing embodiment corresponding to FIG. 2. The terminal device may be the terminal device 20b in the foregoing embodiment corresponding to FIG. 2. To facilitate understanding, this embodiment of this application is described by using an example in which the method is performed by a terminal device. The data processing method may include the following operations S201 to S204.

Operation S201: Invoke, by a service application, an optimization component, and obtain, by the optimization component, a full resource list including full resource configuration information corresponding to a full update resource.

The service application and a business application are applications run in the terminal device. The terminal device may obtain, by the optimization component from the server, a full resource list including full resource configuration information corresponding to a full update resource. For example, the server may include a TGPA background, and a TGPA component may obtain, from the TGPA background, the full resource list including the full resource configuration information corresponding to the full update resource.

Operation S202: Return, by the optimization component, the full resource list to the service application, and instruct, by the full resource list, the service application to download the full update resource in the server, to obtain a pre-downloaded business resource corresponding to a business application.

Specifically, the terminal device may return, by the optimization component, the full resource list to the service application. The full resource configuration information includes a resource specification and a resource address. Further, the terminal device may determine, according to the resource specification, a full resource specification corresponding to the full update resource in the server. Further, if the full resource specification is smaller than a remaining storage space of the terminal device, the terminal device may obtain, by the service application, a full update resource corresponding to the resource address (i.e. the resource address in the full resource configuration information). Further, the terminal device may download the full update resource, to obtain a pre-downloaded business resource corresponding to the business application. In some embodiments, if the full resource specification is greater than or equal to the remaining storage space of the terminal device, the terminal device may not need to download the full update resource.

In some embodiments, if the full resource specification is greater than or equal to the remaining storage space of the terminal device, the terminal device may obtain, by the service application, the full update resource corresponding to the resource address, obtain a download update resource from the full update resource, and further download the download update resource, without downloading update resources other than the download update resource in the full update resource. A download resource specification corresponding to the download update resource is smaller than the remaining storage space of the terminal device. For a specific process in which the terminal device determines the download resource specification corresponding to the download update resource, refer to the following descriptions for determining the full resource specification corresponding to the full update resource.

A quantity of the full resource configuration information may be F, and a quantity of resource specifications may be F, where F may be a positive integer. The process in that the terminal device determines the full resource specification corresponding to the full update resource in the server according to the resource specification means that the terminal device may perform addition operation on the F resource specifications, to obtain the full resource specification corresponding to the full update resource.

The remaining storage space of the terminal device may represent an entire remaining space of the terminal device or a partial remaining space of the terminal device. The partial remaining space is smaller than the entire remaining space. The partial remaining space represents that the partial storage space needs to be reserved for the terminal device, but not the entire remaining space is configured for pre-downloading. For example, the entire remaining space of the terminal device may be 5 gigabytes (G), and the partial remaining space of the terminal device may be 4G.

Operation S203: Obtain, by a business component in response to a trigger operation for the business application, a resource list matching a download mode and an object business feature, and transmit the resource list to the optimization component.

Specifically, in response to the trigger operation for the business application, the terminal device may detect, by the business update component in the business component, the download mode of the business application, determine, if the download mode is a full download mode, the full resource list as a resource list matching the download mode and the object business feature, and transmit the resource list to the optimization component. The full resource configuration information in the resource list may include a resource name and resource digest information. In some embodiments, if the download mode is a differential download mode, the terminal device may filter the full resource configuration information according to an object business feature of a business object corresponding to the terminal device, to obtain differential resource configuration information matching the object business feature, determine, according to the differential resource configuration information, a resource list matching the download mode and the object business feature (to be specific, the differential resource configuration information constitutes the resource list matching the download mode and the object business feature), and transmit the resource list to the optimization component. The differential resource configuration information in the resource list may include a resource name and resource digest information. The object business feature is a business feature of a business object corresponding to the terminal device in the business application. The resource list includes resource configuration information (i.e. full resource configuration information or differential resource configuration information), and a business resource indicated by the resource configuration information belongs to a full update resource (to be specific, a business resource indicated by the full resource configuration information is a full update resource, a business resource indicated by the differential resource configuration information is a differential update resource, and the differential update resource belongs to the full update resource, which may be a part of the full update resource).

The terminal device may obtain, by the business update component, the full resource list from the server, to determine the full resource list as the resource list matching the download mode and the object business feature, or determine the differential resource list as the resource list matching the download mode and the object business feature. In this case, the optimization component and the business update component may separately obtain the full resource list.

The terminal device may transmit, by the business core component in response to the trigger operation for the business application, a migration query request to the optimization component, and instruct, by the migration query request, the optimization component to generate migration success information based on the pre-downloaded business resource in the terminal directory. Further, the terminal device may receive, by the business core component, the migration success information returned by the optimization component, and invoke the business update component according to the migration success information. Further, the terminal device may detect, by the business update component, the download mode of the business application, determine, if the download mode is a full download mode, the full resource list as a resource list matching the download mode and the object business feature, and return the resource list to the business core component. In some embodiments, if the download mode is a differential download mode, the terminal device may filter the full resource configuration information according to an object business feature of a business object corresponding to the terminal device, to obtain differential resource configuration information matching the object business feature, determine, according to the differential resource configuration information, a resource list matching the download mode and the object business feature, and return the resource list to the business core component. Further, the terminal device may transmit, by the business core component, the resource list to the optimization component.

In some embodiments, the terminal device may transmit, by the business core component in response to the trigger operation for the business application, a migration query request to the optimization component, and instruct, by the migration query request, the optimization component to detect the download mode of the business application, to obtain a mode detection result, and then generate migration success information based on the pre-downloaded business resource in the terminal directory and the mode detection result. Further, the terminal device may receive, by the business core component, the migration success information returned by the optimization component, and invoke the business update component according to the migration success information. Further, the terminal device may judge, by the business update component, the mode detection result in the migration success information, determine, if the mode detection result indicates that the download mode is a full download mode, the full resource list as a resource list matching the download mode and the object business feature, and return the resource list to the business core component. In some embodiments, if the mode detection result indicates that the download mode is a differential download mode, the terminal device may filter the full resource configuration information according to an object business feature of a business object corresponding to the terminal device, to obtain differential resource configuration information matching the object business feature, determine, according to the differential resource configuration information, a resource list matching the download mode and the object business feature, and return the resource list to the business core component. Further, the terminal device may transmit, by the business core component, the resource list to the optimization component.

In some embodiments, the terminal device may generate, by the optimization component in response to the trigger operation for the business application, migration success information based on the pre-downloaded business resource in the terminal directory, and invoke the business update component according to the migration success information. Further, the terminal device may detect, by the business update component, the download mode of the business application, determine, if the download mode is a full download mode, the full resource list as a resource list matching the download mode and the object business feature, and transmit the resource list to the optimization component. In some embodiments, if the download mode is a differential download mode, the terminal device may filter the full resource configuration information according to an object business feature of a business object corresponding to the terminal device, to obtain differential resource configuration information matching the object business feature, determine, according to the differential resource configuration information, a resource list matching the download mode and the object business feature, and transmit the resource list to the optimization component.

In some embodiments, the terminal device may detect, by the optimization component in response to the trigger operation for the business application, the download mode of the business application, to obtain a mode detection result, generate migration success information based on the pre-downloaded business resource in the terminal directory and the mode detection result, and invoke the business update component according to the migration success information. Further, the terminal device may judge, by the business update component, the mode detection result in the migration success information, determine, if the mode detection result indicates that the download mode is a full download mode, the full resource list as a resource list matching the download mode and the object business feature, and transmit the resource list to the optimization component. In some embodiments, if the mode detection result indicates that the download mode is a differential download mode, the terminal device may filter the full resource configuration information according to an object business feature of a business object corresponding to the terminal device, to obtain differential resource configuration information matching the object business feature, determine, according to the differential resource configuration information, a resource list matching the download mode and the object business feature, and transmit the resource list to the optimization component.

In some embodiments, the terminal device may further directly determine, by the service application, the download mode of the business application without detecting the download mode of the business application by using the business update component or the optimization component, directly obtain, by the business update component, the download mode determined by the service application, and then obtain, based on the download mode, the resource list matching the download mode and the object business feature.

The business application includes at least two application functions. A specific process in which the terminal device filters the full resource configuration information according to an object business feature of a business object corresponding to the terminal device may be described as: The terminal device may obtain quantities of business objects corresponding to the terminal device used for the at least two application functions, and determine an application function, for which the quantity of business objects used is greater than a quantity threshold, in the at least two application functions as a target application function. Further, the terminal device may determine the target application function as an object business feature of the business object, and obtain, from the full resource configuration information, resource configuration information mapped to the object business feature. To be specific, the terminal device obtains, from the full resource configuration information, an update resource corresponding to the target application function, and resources other than the target application function may not be updated temporarily according to specific needs. Further, the terminal device may determine the obtained resource configuration information as differential resource configuration information matching the object business feature.

In this application, relevant data such as a use quantity is involved. When the foregoing embodiments of this application are applied to a specific product or technology, user permission or consent needs to be obtained, and collection, use, and processing of the relevant data need to comply with relevant laws, regulations, and national standards of relevant countries.

There may be one or more object business features. To be specific, there may be one or more target application functions. The quantity of object business features is not limited in this application. Similarly, there may be one or more pieces of differential resource configuration information. The number of the differential resource configuration information is not limited in this embodiment of this application. One object business feature may be configured for mapping one piece of differential resource configuration information. Alternatively, a plurality of object business features may be configured for mapping one piece of differential resource configuration information. Alternatively, one object business feature may be configured for mapping a plurality of pieces of differential resource configuration information. Alternatively, a plurality of object business features may be configured for mapping a plurality of pieces of differential resource configuration information.

Operation S204: Determine a filter matching resource in the pre-downloaded business resource according to the resource configuration information in the resource list, and migrate the filter matching resource from a terminal directory to an application directory corresponding to the business application.

Specifically, the terminal device may verify, if the resource configuration information in the resource list is full resource configuration information (to be specific, the terminal device determines the full resource list as the resource list matching the download mode and the object business feature in operation S203), the pre-downloaded business resource according to the resource digest information (i.e. the resource digest information in the full resource configuration information), to obtain a first resource verification result, and determine, if the first resource verification result indicates a verification success of the pre-downloaded business resource, the pre-downloaded business resource as a filter matching resource. Further, the filter matching resource is migrated from the terminal directory to an application directory corresponding to the business application. In some embodiments, if the first resource verification result indicates a verification failure of the pre-downloaded business resource, the terminal device does not need to determine the pre-downloaded business resource as a filter matching resource.

For a specific process in which the terminal device verifies the pre-downloaded business resource according to the resource digest information, refer to the descriptions for operation S103 in the foregoing embodiment corresponding to FIG. 3. Details are not described herein again.

In some embodiments, the terminal device may filter, if the resource configuration information in the resource list is differential resource configuration information (to be specific, the terminal device determines, according to the differential resource configuration information, the resource list matching the download mode and the object business feature in operation S203), the pre-downloaded business resource according to the resource name, to obtain a pre-downloaded filtered resource, verify the pre-downloaded filtered resource according to the resource digest information (i.e. the resource digest information in the differential resource configuration information), to obtain a second resource verification result, and determine, if the second resource verification result indicates a verification success of the pre-downloaded filtered resource, the pre-downloaded filtered resource as a filter matching resource. Further, the filter matching resource is migrated from the terminal directory to an application directory corresponding to the business application. In some embodiments, if the second resource verification result indicates a verification failure of the pre-downloaded filtered resource, the terminal device does not need to determine the pre-downloaded filtered resource as a filter matching resource.

For a specific process in which the terminal device filters the pre-downloaded business resource according to the resource name and verifies the pre-downloaded filtered resource according to the resource digest information, refer to the descriptions for operation S103 in the foregoing embodiment corresponding to FIG. 3. Details are not described herein again.

In this embodiment of this application, resources other than the filter matching resource in the pre-downloaded business resource may be determined as an auxiliary business resource. After the terminal device migrates the filter matching resource from the terminal directory to the application directory, the auxiliary business resource may be deleted from the terminal directory, to save the storage space of the terminal device. In some embodiments, after migrating the filter matching resource from the terminal directory to the application directory, the terminal device may not need to delete the auxiliary business resource from the terminal directory.

Therefore, according to a user differentiation pre-downloading method based on a game service channel provided in this embodiment of this application, pre-downloaded business resources may be filtered according to resource names, different filter matching resources are determined for different business objects, and then the different filter matching resources are updated for the different business objects, thereby implementing user differentiation update (in this case, an update resource stored in the terminal device is a full update resource, and an update resource loaded to a business application is a differential update resource). If a business object uses a mode (or module) in the business application for a long time (for example, the business object uses only a gameplay in a game client), an unavailable update resource does not need to be updated for the business object (to be specific, an update resource (i.e. a full update resource) of all modes (or modules) does not need to be updated for the business object), and an update resource (i.e. a filter matching resource) corresponding to a mode (or module) used by the business object is updated (for example, for the business object, a game resource of some modes (or modules) frequently played by the business object is updated). In this case, old resources of some modes (or modules) in the business application that are not used by the business object for a long time are always not used.

Another mode (or module) that is not used (or is not frequently used) by the business object does not need to be updated each time. When the business object is intended to use another mode (or module), the business object loads a latest resource of the another mode (or module) for the business object. In this case, the business application only needs to load resources of one corresponding module, which consumes relatively short time. If the latest resource in another mode (or module) exists in the terminal directory, the terminal device may migrate the latest resource in the another mode (or module) from the terminal directory to the application directory. In some embodiments, if the latest resource in another mode (or module) does not exist in the terminal directory, the terminal device may download the latest resource in the another mode (or module) to the terminal directory, to further migrate the latest resource in the another mode (or module) from the terminal directory to the application directory. Alternatively, the terminal device may download the latest resource in the another mode (or module) to the application directory.

To facilitate understanding, an example in which the business application is a game client is used for description herein. A process in which the game client updates an application may include solution 1 and solution 2. In solution 1: (1) A game service side (i.e. a service application) may download, before a time node for formally issuing a game update (i.e. a time node for formally issuing a full update resource), a pre-downloaded game resource (i.e. a pre-downloaded business resource) uploaded by a TGPA administrator to the game service side in advance for a business object (to be specific, a terminal device may download the pre-downloaded game resource by the game service side). In this case, game resources downloaded by the game service side for all business objects are the same, and are all full game resources (i.e. full update resources) used for the current game update. (2) A business object starts a game (to be specific, the business object performs a trigger operation for the business application), and the game initializes a TGPA component and a game update component. (3) After initialization of the TGPA component is completed, the game queries, from the TGPA component, whether a pre-downloaded file needs to be migrated (namely, determining whether a pre-downloaded business resource exists in a terminal directory), and whether a file migration task needs to be migrated differentially (a full download mode indicates that differential migration is not needed, and a differential download mode indicates that differential migration is needed). (4) Case 1: If the TGPA component returns to the game: If a pre-downloaded file needs to be migrated (to be specific, a pre-downloaded resource exists in the terminal directory), and the file migration task needs to be migrated differentially (to be specific, the download mode is a differential download mode), the game may invoke an application programming interface (API) provided by the game update component, the game update component obtains a pre-downloaded file list (i.e. a differential resource list) of a user characteristic according to a user gameplay (i.e. an object business feature), and returns the differential resource list to the game. Then, the game returns the differential resource list to the TGPA component. The TGPA component migrates a specified game resource (i.e. a filter matching resource) to a local game private directory (i.e. an application directory) according to the differential resource list. Case 2: If the TGPA component returns to the game: If a pre-downloaded file needs to be migrated (to be specific, a pre-downloaded resource exists in the terminal directory), and the file migration task does not need to be migrated differentially (to be specific, the download mode is a full download mode), the game may invoke an API provided by the game update component, the game update component obtains a pre-downloaded file list (i.e. a full resource list), and returns the full resource list to the game. Then, the game returns the full resource list to the TGPA component. The TGPA component migrates all game resources (i.e. filter matching resources) to a local game private directory (i.e. an application directory) according to the full resource list. Case 3: If the TGPA component returns to the game: If no pre-downloaded file needs to be migrated (to be specific, no pre-downloaded resource exists in the terminal directory), after receiving information (i.e. migration failure information), the game does not trigger file migration and a subsequent procedure of updating by using the pre-downloaded file. (5) After the game sets the local game private directory to a pre-downloaded file directory (i.e. a pre-download directory) if a pre-downloaded file needs to be migrated and subsequent migration of a pre-downloaded game resource to the local game private directory is completed, the game update component reads a pre-downloaded game resource (i.e. a filter matching resource) in the directory to update the game (if the pre-downloaded file migrated to the local game private directory is a differential pre-downloaded update file (to be specific, the filter matching resource is a differential update resource), customized update is performed for the business object. If the pre-downloaded file migrated to the local game private directory is a full game update file (to be specific, the filter matching resource is a full update resource), full update of current game update content is performed for the business object).

In solution 2: (1) A game service side (i.e. a service application) may download, before a time node for formally issuing a game update (i.e. a time node for formally issuing a full update resource), a pre-downloaded game resource (i.e. a pre-downloaded business resource) uploaded by a TGPA administrator to the game service side in advance for a business object (to be specific, a terminal device may download the pre-downloaded game resource by the game service side). In this case, game resources downloaded by the game service side for all business objects are the same, and are all full game resources (i.e. full update resources) used for the current game update. (2) A business object starts a game (to be specific, the business object performs a trigger operation for the business application), and the game initializes a TGPA component and a game update component. (3) After initialization of the TGPA component is completed, the TGPA component self-judges whether a pre-downloaded file needs to be migrated (namely, determining whether a pre-downloaded business resource exists in a terminal directory), and whether a file migration task needs to be migrated differentially (a full download mode indicates that differential migration is not needed, and a differential download mode indicates that differential migration is needed). (4) Case 1: If the TGPA component judges: If a pre-downloaded file needs to be migrated (to be specific, a pre-downloaded resource exists in the terminal directory), and the file migration task needs to be migrated differentially (to be specific, the download mode is a differential download mode), the TGPA component may invoke an API provided by the game update component, the game update component obtains a pre-downloaded file list (i.e. a differential resource list) of a user characteristic according to a user gameplay (i.e. an object business feature), and returns the differential resource list to the TGPA component. The TGPA component migrates a specified game resource (i.e. a filter matching resource) to a local game private directory (i.e. an application directory) according to the differential resource list. Case 2: If the TGPA component judges: If a pre-downloaded file needs to be migrated (to be specific, a pre-downloaded resource exists in the terminal directory), and the file migration task does not need to be migrated differentially (to be specific, the download mode is a full download mode), the TGPA component may invoke an API provided by the game update component, the game update component obtains a pre-downloaded file list (i.e. a full resource list), and returns the full resource list to the TGPA component. The TGPA component migrates all game update resources (i.e. filter matching resources) to a local game private directory (i.e. an application directory) according to the full resource list. Case 3: If the TGPA component judges: If no pre-downloaded file needs to be migrated (to be specific, no pre-downloaded resource exists in the terminal directory), the TGPA component does not trigger file migration and a subsequent procedure of updating by using the pre-downloaded file. (5) After the game sets the local game private directory to a pre-downloaded file directory (i.e. a pre-download directory) if a pre-downloaded file needs to be migrated and subsequent migration of a pre-downloaded game resource to the local game private directory is completed, the game update component reads a pre-downloaded game resource (i.e. a filter matching resource) in the directory to update the game (if the pre-downloaded file migrated to the local game private directory is a differential pre-downloaded update file (to be specific, the filter matching resource is a differential update resource), customized update is performed for the business object. If the pre-downloaded file migrated to the local game private directory is a full game update file (to be specific, the filter matching resource is a full update resource), full update of current game update content is performed for the business object).

As can be seen, in this embodiment of this application, a full resource list including full resource configuration information corresponding to a full update resource may be obtained. The full update resource is downloaded based on the full resource configuration information in the full resource list, to obtain a pre-downloaded business resource corresponding to a business application. The pre-downloaded business resource is stored into a terminal directory corresponding to a terminal device. Further, in response to the trigger operation for the business application, the terminal device may obtain a resource list matching the download mode and the object business feature, determine a filter matching resource in the pre-downloaded business resource according to the resource configuration information in the resource list, and then migrate the filter matching resource from the terminal directory to an application directory corresponding to the business application. Therefore, in this embodiment of this application, before responding to a trigger operation for a business application, a full update resource may be pre-download, to obtain a pre-downloaded business resource. Then, after responding to the trigger operation for the business application, the business application is updated based on a filter matching resource in the pre-downloaded business resource, thereby improving update efficiency for the business application.

Further, refer to FIG. 6. FIG. 6 is a schematic flowchart of a data processing method according to an embodiment of this application. The method may be performed by a server, or may be performed by a terminal device, or may be performed by both a server and a terminal device. The server may be the server 20a in the foregoing embodiment corresponding to FIG. 2. The terminal device may be the terminal device 20b in the foregoing embodiment corresponding to FIG. 2. To facilitate understanding, this embodiment of this application is described by using an example in which the method is performed by a terminal device. The data processing method may include the following operations S301 to S306.

Operation S301: Invoke, by a service application, an optimization component, and invoke, by the optimization component, a business update component.

The service application and a business application are applications run in the terminal device.

Operation S302: Obtain, by the business update component, a differential resource list including differential resource configuration information, and return the differential resource list to the optimization component.

The differential resource configuration information is resource configuration information obtained by filtering the full resource configuration information corresponding to the full update resource. For a specific process in which the terminal device filters the full resource configuration information corresponding to the full update resource to obtain differential resource configuration information, refer to the descriptions for operation S203 in the foregoing embodiment corresponding to FIG. 5. Details are not described herein again.

The terminal device may obtain, from the server by the optimization component, a full resource list including the full resource configuration information corresponding to the full update resource, transmit the full resource list to the business update component, and then filter the full resource configuration information in the full resource list by the business update component, to obtain the differential resource configuration information. For example, the server may include a TGPA background, and a TGPA component may obtain, from the TGPA background, the full resource list including the full resource configuration information corresponding to the full update resource. In some embodiments, the terminal device may obtain the full resource list from the server by the business update component, and then filter the full resource configuration information in the full resource list, to obtain the differential resource configuration information.

Operation S303: Return, by the optimization component, the differential resource list to the service application, and instruct, by the differential resource list, the service application to select a full update resource in a server, to obtain a differential update resource.

One piece of resource configuration information may correspond to one update resource. One piece of full resource configuration information may correspond to one piece of full update resource. One piece of differential resource configuration information may correspond to one piece of differential update resource. The differential resource list may instruct the service application to obtain an update resource (i.e. a differential update resource) corresponding to the differential resource configuration information from the full update resource. The differential resource configuration information includes a resource specification and a resource address.

Operation S304: Download, by the service application, the differential update resource, to obtain a pre-downloaded business resource corresponding to a business application.

Specifically, the terminal device may determine, according to the resource specification, a differential resource specification corresponding to the differential update resource in the server. Further, if the differential resource specification is smaller than a remaining storage space of the terminal device, the terminal device may obtain, by the service application, a differential update resource corresponding to the resource address (i.e. the resource address in the differential resource configuration information). Further, the terminal device may download the differential update resource, to obtain a pre-downloaded business resource corresponding to the business application. In some embodiments, if the differential resource specification is greater than or equal to the remaining storage space of the terminal device, the terminal device may not need to download the differential update resource.

For a specific process in which the terminal device determines the differential resource specification corresponding to the differential update resource, refer to the descriptions for determining the full resource specification corresponding to the full update resource in the foregoing embodiment corresponding to FIG. 5 Details are not described herein again. A quantity of differential resource configuration information is less than or equal to a quantity of full resource configuration information. When the quantity of differential resource configuration information is equal to the quantity of full resource configuration information, the full resource list is equal to the differential resource list.

Operation S305: Obtain, by the business component in response to a trigger operation for the business application, a resource list matching a download mode and an object business feature, and transmit the resource list to the optimization component.

Specifically, the terminal device may determine, by the business component in response to a trigger operation for the business application, a differential resource list as a resource list matching a download mode and an object business feature, and transmit the resource list to the optimization component. The differential resource configuration information in the resource list may include a resource name and resource digest information. The object business feature is a business feature of a business object corresponding to the terminal device in the business application. The resource list includes resource configuration information. A business resource indicated by the resource configuration information belongs to the full update resource (to be specific, a business resource indicated by the differential resource configuration information is a differential update resource).

Operation S306: Determine a filter matching resource in the pre-downloaded business resource according to the resource configuration information in the resource list, and migrate the filter matching resource from a terminal directory to an application directory corresponding to the business application.

Specifically, the terminal device may verify the pre-downloaded business resource according to the resource digest information (i.e. the resource digest information in the differential resource configuration information), to obtain a third resource verification result, and determine, if the third resource verification result indicates a verification success of the pre-downloaded business resource, the pre-downloaded business resource as a filter matching resource. Further, the filter matching resource is migrated from the terminal directory to an application directory corresponding to the business application. In some embodiments, if the third resource verification result indicates a verification failure of the pre-downloaded business resource, the pre-downloaded business resource does not need to be determined as a filter matching resource.

For a specific process in which the terminal device verifies the pre-downloaded business resource according to the resource digest information (i.e. the resource digest information in the differential resource configuration information) to obtain a third resource verification result, refer to the descriptions for verifying the pre-downloaded business resource according to the resource digest information (i.e. the resource digest information in the full resource configuration information), to obtain a first resource verification result in the foregoing embodiment corresponding to FIG. 3. Details are not described herein again.

In some embodiments, the terminal device may verify the pre-downloaded business resource according to the resource digest information (i.e. the resource digest information in the differential resource configuration information) and the resource name (i.e. the resource name in the differential resource configuration information), to obtain the third resource verification result. For a specific process in which the terminal device verifies the pre-downloaded business resource according to the resource digest information (i.e. the resource digest information in the differential resource configuration information) and the resource name (i.e. the resource name in the differential resource configuration information) to obtain a third resource verification result, refer to the descriptions for verifying the pre-downloaded business resource according to the resource digest information (i.e. the resource digest information in the full resource configuration information) and the resource name (i.e. the resource name in the full resource configuration information), to obtain a first resource verification result in the foregoing embodiment corresponding to FIG. 3. Details are not described herein again.

Therefore, according to a user differentiation pre-downloading method based on a game service channel provided in this embodiment of this application, different pre-downloaded business resources may be downloaded for different business objects, and then different filter matching resources are updated for the different business objects, thereby implementing user differentiation downloading and update (in this case, an update resource stored in the terminal device is a differential update resource, and an update resource loaded to a business application is a differential update resource). If a business object uses a mode (or module) in the business application for a long time (for example, the business object uses only a gameplay in a game client), an unavailable update resource does not need to be downloaded and updated for the business object (to be specific, an update resource (i.e. a full update resource) of all modes (or modules) does not need to be downloaded and updated for the business object), and an update resource (i.e. a filter matching resource) corresponding to a mode (or module) used by the business object is downloaded and updated (for example, for the business object, a game resource of some modes (or modules) frequently played by the business object is updated), thereby saving traffic for the business object (namely, saving traffic consumed in a downloading process of another update resource that is not used by the business object) and a storage space of the terminal device (namely, saving a storage space of another update resource that is not used by the business object) in the downloading process. In this case, old resources of some modes (or modules) in the business application that are not used by the business object for a long time are always not used.

To facilitate understanding, an example in which the business application is a game client is used for description herein. A process in which the game client updates an application may include solution 1 and solution 2. In solution 1: (1) A game service side (i.e. a service application) may download, before a time node for formally issuing a game update (i.e. a time node for formally issuing a full update resource), a pre-downloaded game resource (i.e. a pre-downloaded business resource) uploaded by a TGPA administrator to the game service side in advance for a use characteristic (i.e. an object business feature) (to be specific, the terminal device may download, by the game service side, a pre-downloaded game resource for the object business feature). Before downloading, the game service side starts a service (i.e. start service), and a sub-process (i.e. a sub-task in the terminal device) is pulled. In the sub-process, the game service side may invoke code of the TGPA component. The TGPA component may invoke code of the game update component. The game update component determines, according to a user gameplay (i.e. an object business feature), which game update resource files (i.e. differential update resources) are to be differentially downloaded for the business object, and returns a differential resource list to the TGPA component. Then, the TGPA component returns the differential resource list to the game service side, and the game service side differentially downloads pre-downloaded files (i.e. differential update resources) for the business object according to the file download list (i.e. the differential resource list). (2) A business object starts a game (to be specific, the business object performs a trigger operation for the business application), and the game initializes a TGPA component and a game update component. (3) After initialization of the TGPA component is completed, the game queries, from the TGPA component, whether a pre-downloaded file needs to be migrated (namely, determining whether a pre-downloaded business resource exists in a terminal directory). (4) Case 1: If the TGPA component returns to the game: A pre-downloaded file needs to be migrated (to be specific, a pre-downloaded resource exists in a terminal directory), and a file migration task does not need to be migrated differentially (since a game resource file (i.e. a differential update resource) is downloaded differentially at a downloading stage, all downloaded files are migrated during file migration herein, and differential migration is not performed again, but full migration is performed on the differential update resource), so that the game may invoke an API provided by the game update component, and the game update component obtains a pre-downloaded file list (i.e. a differential resource list) of a user characteristic according to a user gameplay (i.e. an object business feature), and returns the differential resource list to the game. Then, the game returns the differential resource list to the TGPA component. The TGPA component migrates all game resources (i.e. filter matching resources) to a local game private directory (i.e. an application directory) according to the differential resource list. Case 2: If the TGPA component returns to the game: If no pre-downloaded file needs to be migrated (to be specific, no pre-downloaded resource exists in the terminal directory), after receiving information (i.e. migration failure information), the game does not trigger file migration and a subsequent procedure of updating by using the pre-downloaded file. (5) After the game sets the local game private directory to a pre-downloaded file directory (i.e. a pre-download directory) if a pre-downloaded file needs to be migrated and subsequent migration of a pre-downloaded game resource to the local game private directory is completed, the game update component reads a pre-downloaded game resource (i.e. a filter matching resource) in the directory to perform customized update of the game for a user.

In solution 2: (1) A game service side (i.e. a service application) may download, before a time node for formally issuing a game update (i.e. a time node for formally issuing a full update resource), a pre-downloaded game resource (i.e. a pre- downloaded business resource) uploaded by a TGPA administrator to the game service side in advance for a use characteristic (i.e. an object business feature) (to be specific, the terminal device may download, by the game service side, a pre-downloaded game resource for the object business feature). Before downloading, the game service side starts a service (i.e. start service), and a sub-process (i.e. a sub-task in the terminal device) is pulled. In the sub-process, the game service side may invoke code of the TGPA component. The TGPA component may invoke code of the game update component. The game update component determines, according to a user gameplay (i.e. an object business feature), which game update resource files (i.e. differential update resources) are to be differentially downloaded for the business object, and returns a differential resource list to the TGPA component. Then, the TGPA component returns the differential resource list to the game service side, and the game service side differentially downloads pre-downloaded files (i.e. differential update resources) for the business object according to the file download list (i.e. the differential resource list). (2) A business object starts a game (to be specific, the business object performs a trigger operation for the business application), and the game initializes a TGPA component and a game update component. (3) After initialization of the TGPA component is completed, the TGPA component self-judges whether a pre-downloaded file needs to be migrated (namely, determining whether a pre-downloaded business resource exists in a terminal directory). (4) Case 1: If the TGPA component judges: A pre-downloaded file needs to be migrated (to be specific, a pre-downloaded resource exists in a terminal directory), and a file migration task does not need to be migrated differentially (since a game resource file (i.e. a differential update resource) is downloaded differentially at a downloading stage, all downloaded files are migrated during file migration herein, and differential migration is not performed again, but full migration is performed on the differential update resource), so that the TGPA component may invoke an API provided by the game update component, and the game update component obtains a pre-downloaded file list (i.e. a differential resource list) of a user characteristic according to a user gameplay (i.e. an object business feature), and returns the differential resource list to the TGPA component. The TGPA component migrates all game update resources (i.e. filter matching resources) to a local game private directory (i.e. an application directory) according to the differential resource list. Case 2: If the TGPA component judges: If no pre-downloaded file needs to be migrated (to be specific, no pre-downloaded resource exists in the terminal directory), the TGPA component does not trigger file migration and a subsequent procedure of updating by using the pre-downloaded file. (5) After the game sets the local game private directory to a pre-downloaded file directory (i.e. a pre-download directory) if a pre-downloaded file needs to be migrated and subsequent migration of a pre-downloaded game resource to the local game private directory is completed, the game update component reads a pre-downloaded game resource (i.e. a filter matching resource) in the directory to update the game, for performing customized update for a user.

As can be seen, in this embodiment of this application, a differential resource list including differential resource configuration information corresponding to a differential update resource may be obtained. The differential update resource in a full update resource is downloaded based on the differential resource configuration information in the differential resource list, to obtain a pre-downloaded business resource corresponding to a business application. The pre-downloaded business resource is stored into a terminal directory corresponding to a terminal device. Further, in response to the trigger operation for the business application, the terminal device may obtain a resource list matching the download mode and the object business feature, determine a filter matching resource in the pre-downloaded business resource according to the resource configuration information in the resource list, and then migrate the filter matching resource from the terminal directory to an application directory corresponding to the business application. Therefore, in this embodiment of this application, before responding to a trigger operation for a business application, a differential update resource may be pre-download, to obtain a pre-downloaded business resource. Then, after responding to the trigger operation for the business application, the business application is updated based on a filter matching resource in the pre-downloaded business resource, thereby improving update efficiency for the business application.

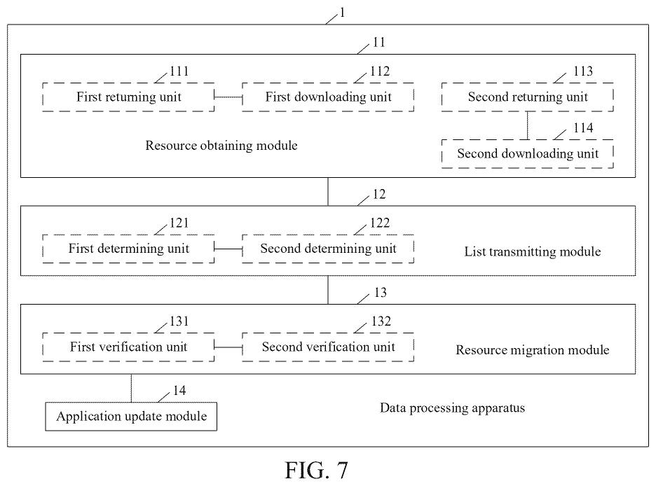

Further, refer to FIG. 7. FIG. 7 is a schematic structural diagram of a data processing apparatus according to an embodiment of this application. The data processing apparatus 1 may include: a resource obtaining module 11, a list transmitting module 12, a resource migration module 13, and an application update module 14.

The resource obtaining module 11 is configured to obtain a pre-downloaded business resource corresponding to a business application, and store the pre-downloaded business resource into a terminal directory corresponding to a terminal device. The business application includes an optimization component and a business component. The pre-downloaded business resource is obtained based on a full update resource in a server.

The resource obtaining module 11 includes: a first returning unit 111 and a first downloading unit 112. The first returning unit 111 is configured to invoke, by a service application, the optimization component, and obtain, by the optimization component, a full resource list including full resource configuration information corresponding to the full update resource. The service application and the business application are applications run in the terminal device. The first downloading unit 112 is configured to return, by the optimization component, the full resource list to the service application, and instruct, by the full resource list, the service application to download the full update resource in the server, to obtain a pre-downloaded business resource corresponding to the business application.

The full resource configuration information includes a resource specification and a resource address. The first downloading unit 112 is specifically configured to determine, according to the resource specification, a full resource specification corresponding to the full update resource in the server. The first downloading unit 112 is specifically configured to obtain, by the service application, a full update resource corresponding to the resource address if the full resource specification is smaller than a remaining storage space of the terminal device. The first downloading unit 112 is specifically configured to download the full update resource, to obtain a pre-downloaded business resource corresponding to the business application.

For specific implementations of the first returning unit 111 and the first downloading unit 112, refer to the descriptions for operation S201 to operation S202 in the foregoing embodiment corresponding to FIG. 5. Details are not described herein again.

The business component includes a business update component. The resource obtaining module 11 includes: a second returning unit 113 and a second downloading unit 114. The second returning unit 113 is configured to invoke, by a service application, the optimization component, and invoke, by the optimization component, the business update component. The service application and the business application are applications run in the terminal device. The second returning unit 113 is configured to obtain, by the business update component, a differential resource list including differential resource configuration information, and return the differential resource list to the optimization component. The differential resource configuration information is resource configuration information obtained by filtering full resource configuration information corresponding to the full update resource. The second downloading unit 114 is configured to return, by the optimization component, the differential resource list to the service application, and instruct, by the differential resource list, the service application to select the full update resource in the server, to obtain a differential update resource. The second downloading unit 114 is configured to download, by the service application, the differential update resource, to obtain a pre-downloaded business resource corresponding to the business application.

For specific implementations of the second returning unit 113 and the second downloading unit 114, refer to the descriptions for operation S301 to operation S304 in the foregoing embodiment corresponding to FIG. 6. Details are not described herein again.

The list transmitting module 12 is configured to obtain, by the business component in response to a trigger operation for the business application, a resource list matching a download mode and an object business feature, and transmit the resource list to the optimization component. The object business feature is a business feature of a business object corresponding to the terminal device in the business application. The resource list includes resource configuration information. A business resource indicated by the resource configuration information belongs to the full update resource.

The business component includes a business update component. The list transmitting module 12 includes: a first determining unit 121 and a second determining unit 122. The first determining unit 121 is configured to detect, by the business update component, the download mode of the business application, and determine, if the download mode is a full download mode, the full resource list as a resource list matching the download mode and the object business feature. The second determining unit 122 is configured to filter, if the download mode is a differential download mode, the full resource configuration information according to an object business feature of a business object corresponding to the terminal device, to obtain differential resource configuration information matching the object business feature, and determine, according to the differential resource configuration information, a resource list matching the download mode and the object business feature.

The business application includes at least two application functions. The second determining unit 122 is specifically configured to obtain quantities of business objects corresponding to the terminal device used for the at least two application functions, and determine an application function, for which the quantity of business objects used is greater than a quantity threshold, in the at least two application functions as a target application function. The second determining unit 122 is specifically configured to determine the target application function as an object business feature of the business object, and obtain, from the full resource configuration information, resource configuration information mapped to the object business feature. The second determining unit 122 is specifically configured to determine the obtained resource configuration information as differential resource configuration information matching the object business feature.

For specific implementations of the first determining unit 121 and the second determining unit 122, refer to the descriptions for operation S203 in the foregoing embodiment corresponding to FIG. 5. Details are not described herein again.

The business component includes a business core component and a business update component. The list transmitting module 12 is specifically configured to transmit, by the business core component in response to the trigger operation for the business application, a migration query request to the optimization component, and instruct, by the migration query request, the optimization component to generate migration success information based on the pre-downloaded business resource in the terminal directory. The list transmitting module 12 is specifically configured to receive, by the business core component, the migration success information returned by the optimization component, and invoke the business update component according to the migration success information. The list transmitting module 12 is specifically configured to obtain, by the business update component, a resource list matching the download mode and the object business feature, and return the resource list to the business core component. The list transmitting module 12 is specifically configured to transmit, by the business core component, the resource list to the optimization component.

The business component includes a business update component. The list transmitting module 12 is specifically configured to generate, by the optimization component in response to the trigger operation for the business application, migration success information based on the pre-downloaded business resource in the terminal directory, and invoke the business update component according to the migration success information. The list transmitting module 12 is specifically configured to obtain, by the business update component, a resource list matching the download mode and the object business feature, and transmit the resource list to the optimization component. The resource migration module 13 is configured to determine a filter matching resource in the pre-downloaded business resource according to the resource configuration information in the resource list, and migrate the filter matching resource from the terminal directory to an application directory corresponding to the business application.

The resource configuration information in the resource list includes a resource name and resource digest information. The resource migration module 13 includes: a first verification unit 131 and a second verification unit 132. The first verification unit 131 is configured to verify, if the resource configuration information in the resource list is full resource configuration information, the pre-downloaded business resource according to the resource digest information, to obtain a first resource verification result, and determine, if the first resource verification result indicates a verification success of the pre-downloaded business resource, the pre-downloaded business resource as a filter matching resource.

The first verification unit 131 is specifically configured to perform hash calculation on the pre-downloaded business resource, to obtain download digest information corresponding to the pre-downloaded business resource, and match the download digest information with the resource digest information. The first verification unit 131 is specifically configured to generate, if the download digest information is the same as the resource digest information, a first resource verification result for indicating a verification success of the pre-downloaded business resource. The first verification unit 131 is specifically configured to generate, if the download digest information and the resource digest information are different, a first resource verification result for indicating a verification failure of the pre-downloaded business resource. The second verification unit 132 is configured to filter, if the resource configuration information in the resource list is differential resource configuration information, the pre-downloaded business resource according to the resource name, to obtain a pre-downloaded filtered resource, verify the pre-downloaded filtered resource according to the resource digest information, to obtain a second resource verification result, and determine, if the second resource verification result indicates a verification success of the pre-downloaded filtered resource, the pre-downloaded filtered resource as a filter matching resource.

For specific implementations of the first verification unit 131 and the second verification unit 132, refer to the descriptions for operation S103 in the foregoing embodiment corresponding to FIG. 3 and operation S204 in the foregoing embodiment corresponding to FIG. 5. Details are not described herein again.

The application update module 14 is configured to update the business application based on the filter matching resource in the application directory.

The application update module 14 is specifically configured to set the application directory to a pre-download directory, and read the filter matching resource in the pre-download directory. The application update module 14 is specifically configured to update the business application according to the filter matching resource.

For specific implementations of the resource obtaining module 11, the list transmitting module 12, the resource migration module 13, and the application update module 14, refer to the descriptions for operation S101 to operation S104 in the foregoing embodiment corresponding to FIG. 3, operation S201 to operation S204 in the foregoing embodiment corresponding to FIG. 5, and operation S301 to operation S306 in the foregoing embodiment corresponding to FIG. 6. Details are not described herein again. In addition, the descriptions for beneficial effects of the same method are not described herein again.

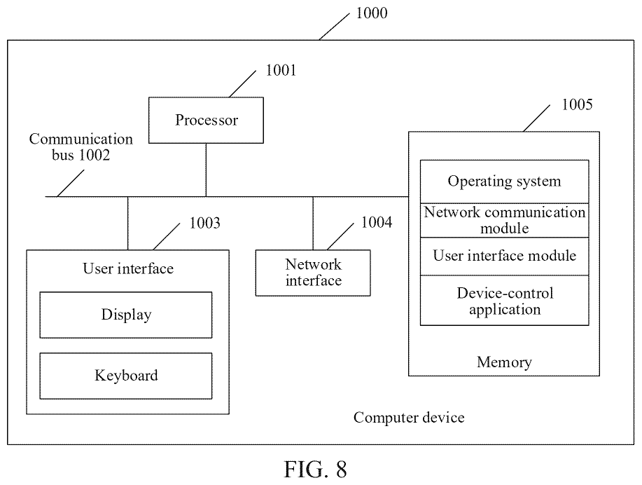

Further, refer to FIG. 8. FIG. 8 is a schematic structural diagram of a computer device according to an embodiment of this application. The computer device may be a terminal device or a server. As shown in FIG. 8, the computer device 1000 may include: a processor 1001, a network interface 1004, and a memory 1005. Furthermore, the computer device 1000 may further include: a user interface 1003 and at least one communication bus 1002. The communication bus 1002 is configured to implement connection and communication between the components. In some embodiments, the user interface 1003 may include a display and a keyboard. The user interface 1003 may alternatively include a standard wired interface and a standard wireless interface. In some embodiments, the network interface 1004 may include a standard wired interface and a standard wireless interface (e.g. a WI-FI interface). The memory 1005 may be a high-speed random access memory (RAM), and may alternatively be a non-volatile memory, for example, at least one disk memory. In some embodiments, the memory 1005 may further be at least one storage apparatus that is located far away from the foregoing processor 1001. As shown in FIG. 8, the memory 1005 used as a computer-readable storage medium may include an operating system, a network communication module, a user interface module, and a device-control application.

In the computer device 1000 shown in FIG. 8, the network interface 1004 may provide a network communication function. The user interface 1003 is mainly configured to provide an input interface for a user. The processor 1001 may be configured to invoke the device-control application stored in the memory 1005 to:
obtain a pre-downloaded business resource corresponding to a business application, and store the pre-downloaded business resource into a terminal directory corresponding to a terminal device, where the business application includes an optimization component and a business component, and the pre-downloaded business resource is obtained based on a full update resource in a server;
obtain, by the business component in response to a trigger operation for the business application, a resource list matching a download mode and an object business feature, and transmit the resource list to the optimization component, where the object business feature is a business feature of a business object corresponding to the terminal device in the business application, the resource list includes resource configuration information, and a business resource indicated by the resource configuration information belongs to the full update resource;
determine a filter matching resource in the pre-downloaded business resource according to the resource configuration information in the resource list, and migrate the filter matching resource from the terminal directory to an application directory corresponding to the business application; and
update the business application based on the filter matching resource in the application directory.

The computer device 1000 described in this embodiment of this application may implement the descriptions for the data processing method in the foregoing embodiment corresponding to FIG. 3, FIG. 5, or FIG. 6, and may alternatively implement the descriptions for the data processing apparatus 1 in the foregoing embodiment corresponding to FIG. 7. Details are not described herein again. In addition, the descriptions for beneficial effects of the same method are not described herein again.

Furthermore, embodiments of this application further provide a non-transitory computer-readable storage medium, and the computer-readable storage medium has a computer program, executed by the foregoing data processing apparatus 1, stored therein. When a processor executes the computer program, the descriptions for the data processing method in the foregoing embodiment corresponding to FIG. 3, FIG. 5, or FIG. 6 can be implemented. Therefore, details are not described herein again. In addition, the descriptions for beneficial effects of the same method are not described herein again. For technical details that are not disclosed in the computer-readable storage medium embodiments of this application, refer to the descriptions for the method embodiments of this application.

Furthermore, embodiments of this application further provide a computer program product. The computer program product may include a computer program, and the computer program may be stored in a computer-readable storage medium. A processor of a computer device reads the computer program from the computer-readable storage medium, and the processor may execute the computer program, to cause the computer device to implement the descriptions for the data processing method in the foregoing embodiment corresponding to FIG. 3, FIG. 5, or FIG. 6. Therefore, details are not described herein again. In addition, the descriptions for beneficial effects of the same method are not described herein again. For technical details that are not disclosed in the computer program product embodiments of this application, refer to the descriptions for the method embodiments of this application.

All or some of the procedures of the methods in the foregoing embodiments may be implemented by a computer program instructing relevant hardware. The computer program may be stored in a computer-readable storage medium. When the program is executed, the procedures of the foregoing method embodiments may be included. The storage medium may be a magnetic disk, an optical disc, a read-only memory (ROM), a RAM, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data processing method performed by a computer device, the method comprising:
storing a pre-downloaded business resource corresponding to a business application into a terminal directory corresponding to a terminal device, the business application comprising an optimization component and a business component;
obtaining, in response to a trigger operation for the business application, a resource list matching a download mode and an object business feature, and transmitting the resource list to the optimization component, the object business feature being a business feature of a business object corresponding to the terminal device in the business application, the resource list comprising resource configuration information, and a business resource indicated by the resource configuration information belonging to the full update resource;
determining a filter matching resource in the pre-downloaded business resource according to the resource configuration information in the resource list, and migrating the filter matching resource from the terminal directory to an application directory corresponding to the business application; and
updating the business application based on the filter matching resource in the application directory.

2. The method according to claim 1, wherein the business component comprises a business core component and a business update component; and
the obtaining, in response to a trigger operation for the business application, a resource list matching a download mode and an object business feature, and transmitting the resource list to the optimization component comprises:
transmitting, by the business core component, a migration query request to the optimization component, and instructing, by the migration query request, the optimization component to generate migration success information based on the pre-downloaded business resource in the terminal directory;
receiving, by the business core component, the migration success information returned by the optimization component, and invoking the business update component according to the migration success information;
obtaining, by the business update component, a resource list matching the download mode and the object business feature, and returning the resource list to the business core component; and
transmitting, by the business core component, the resource list to the optimization component.

3. The method according to claim 1, wherein the business component comprises a business update component; and
the obtaining, in response to a trigger operation for the business application, a resource list matching a download mode and an object business feature, and transmitting the resource list to the optimization component comprises:
generating, by the optimization component in response to the trigger operation for the business application, migration success information based on the pre-downloaded business resource in the terminal directory, and invoking the business update component according to the migration success information; and
obtaining, by the business update component, a resource list matching the download mode and the object business feature, and transmitting the resource list to the optimization component.

4. The method according to claim 1, wherein the obtaining a pre-downloaded business resource corresponding to a business application comprises:
invoking, by a service application, the optimization component, and obtaining, by the optimization component, a full resource list comprising full resource configuration information corresponding to the full update resource, the service application and the business application being applications run in the terminal device; and
returning, by the optimization component, the full resource list to the service application, and instructing, by the full resource list, the service application to download the full update resource in the server, to obtain a pre-downloaded business resource corresponding to the business application.

5. The method according to claim 4, wherein the business component comprises a business update component; and
the obtaining, by the business component, a resource list matching the download mode and the object business feature comprises:
detecting, by the business update component, the download mode of the business application, and determining, if the download mode is a full download mode, the full resource list as a resource list matching the download mode and the object business feature; and
filtering, if the download mode is a differential download mode, the full resource configuration information according to an object business feature of a business object corresponding to the terminal device, to obtain differential resource configuration information matching the object business feature, and determining, according to the differential resource configuration information, a resource list matching the download mode and the object business feature.

6. The method according to claim 4, wherein the full resource configuration information comprises a resource specification and a resource address; and
the instructing, by the full resource list, the service application to download the full update resource in the server to obtain a pre-downloaded business resource corresponding to the business application comprises:
determining, according to the resource specification, a full resource specification corresponding to the full update resource in the server;
obtaining, by the service application, a full update resource corresponding to the resource address if the full resource specification is smaller than a remaining storage space of the terminal device; and
downloading the full update resource, to obtain a pre-downloaded business resource corresponding to the business application.

7. The method according to claim 1, wherein the business component comprises a business update component; and
the obtaining a pre-downloaded business resource corresponding to a business application comprises:
invoking, by a service application, the optimization component, and invoking, by the optimization component, the business update component, the service application and the business application being applications run in the terminal device;
obtaining, by the business update component, a differential resource list comprising differential resource configuration information, and returning the differential resource list to the optimization component, the differential resource configuration information being resource configuration information obtained by filtering full resource configuration information corresponding to the full update resource;
returning, by the optimization component, the differential resource list to the service application, and instructing, by the differential resource list, the service application to select the full update resource in the server, to obtain a differential update resource; and
downloading, by the service application, the differential update resource, to obtain a pre-downloaded business resource corresponding to the business application.

8. The method according to claim 1, wherein the updating the business application based on the filter matching resource in the application directory comprises:
setting the application directory to a pre-download directory, and reading the filter matching resource in the pre-download directory; and
updating the business application according to the filter matching resource.

9. A computer device, comprising: a processor and a memory, the processor and the memory being connected, the memory being configured to store a computer program, and the processor being configured to invoke the computer program, to cause the computer device to perform a data processing method including:
storing a pre-downloaded business resource corresponding to a business application into a terminal directory corresponding to a terminal device, the business application comprising an optimization component and a business component;
obtaining, in response to a trigger operation for the business application, a resource list matching a download mode and an object business feature, and transmitting the resource list to the optimization component, the object business feature being a business feature of a business object corresponding to the terminal device in the business application, the resource list comprising resource configuration information, and a business resource indicated by the resource configuration information belonging to the full update resource;
determining a filter matching resource in the pre-downloaded business resource according to the resource configuration information in the resource list, and migrating the filter matching resource from the terminal directory to an application directory corresponding to the business application; and
updating the business application based on the filter matching resource in the application directory.

10. The computer device according to claim 9, wherein the business component comprises a business core component and a business update component; and
the obtaining, in response to a trigger operation for the business application, a resource list matching a download mode and an object business feature, and transmitting the resource list to the optimization component comprises:
transmitting, by the business core component, a migration query request to the optimization component, and instructing, by the migration query request, the optimization component to generate migration success information based on the pre-downloaded business resource in the terminal directory;
receiving, by the business core component, the migration success information returned by the optimization component, and invoking the business update component according to the migration success information;
obtaining, by the business update component, a resource list matching the download mode and the object business feature, and returning the resource list to the business core component; and
transmitting, by the business core component, the resource list to the optimization component.

11. The computer device according to claim 9, wherein the business component comprises a business update component; and
the obtaining, in response to a trigger operation for the business application, a resource list matching a download mode and an object business feature, and transmitting the resource list to the optimization component comprises:
generating, by the optimization component in response to the trigger operation for the business application, migration success information based on the pre-downloaded business resource in the terminal directory, and invoking the business update component according to the migration success information; and
obtaining, by the business update component, a resource list matching the download mode and the object business feature, and transmitting the resource list to the optimization component.

12. The computer device according to claim 9, wherein the obtaining a pre-downloaded business resource corresponding to a business application comprises:
invoking, by a service application, the optimization component, and obtaining, by the optimization component, a full resource list comprising full resource configuration information corresponding to the full update resource, the service application and the business application being applications run in the terminal device; and
returning, by the optimization component, the full resource list to the service application, and instructing, by the full resource list, the service application to download the full update resource in the server, to obtain a pre-downloaded business resource corresponding to the business application.

13. The computer device according to claim 12, wherein the business component comprises a business update component; and
the obtaining, by the business component, a resource list matching the download mode and the object business feature comprises:
detecting, by the business update component, the download mode of the business application, and determining, if the download mode is a full download mode, the full resource list as a resource list matching the download mode and the object business feature; and
filtering, if the download mode is a differential download mode, the full resource configuration information according to an object business feature of a business object corresponding to the terminal device, to obtain differential resource configuration information matching the object business feature, and determining, according to the differential resource configuration information, a resource list matching the download mode and the object business feature.

14. The computer device according to claim 12, wherein the full resource configuration information comprises a resource specification and a resource address; and
the instructing, by the full resource list, the service application to download the full update resource in the server to obtain a pre-downloaded business resource corresponding to the business application comprises:
determining, according to the resource specification, a full resource specification corresponding to the full update resource in the server;
obtaining, by the service application, a full update resource corresponding to the resource address if the full resource specification is smaller than a remaining storage space of the terminal device; and
downloading the full update resource, to obtain a pre-downloaded business resource corresponding to the business application.

15. The computer device according to claim 9, wherein the business component comprises a business update component; and
the obtaining a pre-downloaded business resource corresponding to a business application comprises:
invoking, by a service application, the optimization component, and invoking, by the optimization component, the business update component, the service application and the business application being applications run in the terminal device;
obtaining, by the business update component, a differential resource list comprising differential resource configuration information, and returning the differential resource list to the optimization component, the differential resource configuration information being resource configuration information obtained by filtering full resource configuration information corresponding to the full update resource;
returning, by the optimization component, the differential resource list to the service application, and instructing, by the differential resource list, the service application to select the full update resource in the server, to obtain a differential update resource; and
downloading, by the service application, the differential update resource, to obtain a pre-downloaded business resource corresponding to the business application.

16. The computer device according to claim 9, wherein the updating the business application based on the filter matching resource in the application directory comprises:
setting the application directory to a pre-download directory, and reading the filter matching resource in the pre-download directory; and
updating the business application according to the filter matching resource.

17. A non-transitory computer-readable storage medium having a computer program stored therein, the computer program being adapted to be loaded and executed by a processor of a computer device to cause the computer device to perform a data processing method including:
storing a pre-downloaded business resource corresponding to a business application into a terminal directory corresponding to a terminal device, the business application comprising an optimization component and a business component;
obtaining, in response to a trigger operation for the business application, a resource list matching a download mode and an object business feature, and transmitting the resource list to the optimization component, the object business feature being a business feature of a business object corresponding to the terminal device in the business application, the resource list comprising resource configuration information, and a business resource indicated by the resource configuration information belonging to the full update resource;
determining a filter matching resource in the pre-downloaded business resource according to the resource configuration information in the resource list, and migrating the filter matching resource from the terminal directory to an application directory corresponding to the business application; and
updating the business application based on the filter matching resource in the application directory.

18. The non-transitory computer-readable storage medium according to claim 17, wherein the business component comprises a business core component and a business update component; and
the obtaining, in response to a trigger operation for the business application, a resource list matching a download mode and an object business feature, and transmitting the resource list to the optimization component comprises:
transmitting, by the business core component, a migration query request to the optimization component, and instructing, by the migration query request, the optimization component to generate migration success information based on the pre-downloaded business resource in the terminal directory;
receiving, by the business core component, the migration success information returned by the optimization component, and invoking the business update component according to the migration success information;
obtaining, by the business update component, a resource list matching the download mode and the object business feature, and returning the resource list to the business core component; and
transmitting, by the business core component, the resource list to the optimization component.

19. The non-transitory computer-readable storage medium according to claim 17, wherein the business component comprises a business update component; and
the obtaining, in response to a trigger operation for the business application, a resource list matching a download mode and an object business feature, and transmitting the resource list to the optimization component comprises:
generating, by the optimization component in response to the trigger operation for the business application, migration success information based on the pre-downloaded business resource in the terminal directory, and invoking the business update component according to the migration success information; and
obtaining, by the business update component, a resource list matching the download mode and the object business feature, and transmitting the resource list to the optimization component.

20. The non-transitory computer-readable storage medium according to claim 17, wherein the obtaining a pre-downloaded business resource corresponding to a business application comprises:
invoking, by a service application, the optimization component, and obtaining, by the optimization component, a full resource list comprising full resource configuration information corresponding to the full update resource, the service application and the business application being applications run in the terminal device; and
returning, by the optimization component, the full resource list to the service application, and instructing, by the full resource list, the service application to download the full update resource in the server, to obtain a pre-downloaded business resource corresponding to the business application.
